(19) United States
(12) Patent Application Publication
(10) Pub. No.: US 2007/0150954 A1
(43) Pub. Date: Jun. 28, 2007

(54) System and method for detecting network intrusion

(76) Inventor: Tae-Shik Shon, Suwon-si (KR)

Correspondence Address: Robert E Bushnell, Suite 300, 1522 K Street, N.W., Washington, DC, 20005-1202, US

(21) Appl. No.: 11/604,229

(22) Filed: Nov. 27, 2006

(30) Foreign Application Priority Data
Dec. 27, 2005 (KR) 10-2005-0130889

(51) Int. Cl. G06F 12/14

(52) U.S. Cl. 726/23

(57) ABSTRACT

In a system and method for detecting network intrusion, the system comprises: a packet capturer which captures at least one packet on a network; a preprocessor which provides feature values dependent on features of each packet captured by the packet capturer; and a learning engine for classifying patterns dependent on the feature values provided by the preprocessor into two different pattern sets, and for selecting one pattern set having more elements from the pattern sets as a reference set so as to detect network intrusion. The network intrusion detection system and method do not depend on historical data according to known attack patterns, and thus not only detect a changed attack pattern but also efficiently detect network intrusion.

### CLAIM OF PRIORITY

This application makes reference to, incorporates the same herein, and claims all benefits accruing under 35 U.S.C. §119 from an application for METHOD AND APPARATUS FOR NETWORK INTRUSION DETECTION earlier filed in the Korean Intellectual Property Office on the 27^{th} of Dec. 2005 and there duly assigned Serial No. 10-2005-0130889.

### BACKGROUND OF THE INVENTION

1. Technical Field

The present invention relates to a system and method for detecting network intrusion.

2. Related Art

With the development of network technology and the increase in network users, an information oriented society is developing, but negative aspects, such as spreading of a virus to other users and attacking of other users through a network, are also increasing.

In order to detect such network intrusion, an intrusion detection system has been proposed. The intrusion detection system detects an abnormal act, misuse, and the like on a network in real time.

Network intrusion detection techniques can be roughly classified into misuse detection and anomaly detection.

The misuse detection technique creates a signature or rule set for known attack patterns, and identifies a pattern matching the created signature or rule set to detect an attack. The misuse detection technique includes pattern matching, an expert system, a state transition model, key-stroke monitoring, and the like.

The anomaly detection technique creates a normal profile for a normal act, and considers acts deviating from the generated normal profile as attacks. The anomaly detection technique includes a statistical method, a neural network method, a predictable pattern creating method, and the like.

However, the general intrusion detection technique requires historical data in order to detect a misuse or abnormal act, and thus it cannot detect a misuse or abnormal act deviating from the historical data.

For example, the misuse detection technique requires historical data to generate a signature or rule set for known attack patterns, and thus it cannot detect a pattern deviating from the signature or rule set.

In addition, since the anomaly detection technique creates a normal profile for detecting an abnormal act based on the historical data, a detection reference is dependent on the historical data, and a large amount of learning data is required for a learning process to generate the normal profile.

### SUMMARY OF THE INVENTION

It is an object of the present invention to provide a system and method for detecting network intrusion, the system and method being capable of detecting a changed attack pattern and efficiently detecting network intrusion without depending on historical data dependent on known attack patterns.

According to an aspect of the present invention, a system for detecting network intrusion comprises: a packet capturer for capturing at least one packet on a network; a preprocessor for providing feature values dependent on features of each packet captured by the packet capturer; and a learning engine for classifying patterns dependent on the feature values provided by the preprocessor into two different pattern sets, and for selecting one pattern set having more elements from the pattern sets as a reference set so as to detect network intrusion.

The preprocessor provides the feature values corresponding to field values of the packet.

The learning engine comprises: a learning unit for generating a hyperplane classifying the patterns dependent on the feature values into the two different pattern sets, for converging a bias term to the origin of a two-dimension plane so as to select the reference set, and for generating a reference profile dependent on patterns of the reference set; and a detection unit for comparing a packet feature value on the network with the reference profile so as to detect network intrusion.

According to another aspect of the present invention, a system for detecting network intrusion comprises: a learning unit for classifying a pattern dependent on at least one packet feature value on a network into two different pattern sets using a support vector machine (SVM) technique, for adjusting the position of a hyperplane classifying the pattern sets, and for generating a reference profile according to one reference set; and a detection unit for comparing a packet feature value on the network with the reference profile so as to detect network intrusion.

The learning unit classifies the respective patterns using the following formula:

$${Minimize }_{w , b , Ξ} Φ ( w , b , Ξ ) = \frac{1}{2} {‖ w ‖}^{2} + C {\sum }_{i = 1}^{l} {ξ}_{i}^{k}$$

$$Subject to {y}_{i} ( {ω}^{T} φ ( {x}_{i} ) + b ) \geq 1 - {ξ}_{i} , {ξ}_{i} \geq 0 , i = 1 , l$$

where ω is an adjustable weight vector variable, xᵢ is an input-pattern vector variable, b is a bias term variable, and ξ is an error-correction variable.

The learning unit causes the bias term of the hyperplane (ω^{T}xᵢ+b=0), classifying the patterns into the two pattern sets, to be converged to the origin of a two-dimension plane, and selects the reference set using the following formula:

soft margin SVM without a bias≅one-class SVM

$$\frac{1}{2} {‖ w ‖}^{2} + C {\sum }_{i = 1}^{l} {ξ}_{i}^{k} ≅ \frac{1}{2} {‖ w ‖}^{2} + \frac{1}{vl} {\sum }_{i - 1}^{l} {ξ}_{i}^{k} - p$$

$${y}_{i} ( {ω}^{T} φ ( {x}_{i} ) ) \geq 1 - {ξ}_{i} , ≅ {y}_{i} ( {ω}^{T} φ ( {x}_{i} ) ) \geq p - {ξ}_{i} , \\ 0 < v < 1 , 1 < 1 , 0 \leq p$$

where v is a variable representing the distance from the origin to the hyperplane, and l is a variable representing the maximum number of elements in a pattern set.

The learning unit selects the reference set of the pattern using the following formula:

$$Minimize \frac{1}{2} {‖ w ‖}^{2} + C {\sum }_{i = 1}^{l} {ξ}_{i}^{k} - E , 0 < C < 1$$

$$Subject to {y}_{i} ( {ω}^{T} φ ( {x}_{i} ) ) \geq E - ξ , 0 < E < 1$$

where w is an adjustable weight vector variable, xᵢ is an input-pattern vector variable, b is a bias term variable, and ξ is an error-correction variable.

The learning unit generates the hyperplane classifying the respective patterns according to a SVM technique by mapping patterns of each packet to a higher dimension plane, and processes patterns which are mapped to a two-dimension plane using a feature mapping function and thus located at the origin as outliers.

According to still another aspect of the present invention, a method for detecting network intrusion comprises the steps of: capturing at least one packet on a network; deriving feature values dependent on features of each captured packet; classifying patterns according to feature values into two different pattern sets; selecting one pattern set which has more elements than the other pattern set as a reference set and generating a reference profile; and comparing the feature value of a packet with the reference profile so as to detect network intrusion.

In the step of deriving feature values, the feature values corresponding to field values of the packet are derived.

In the step of classifying patterns, a hyperplane classifying the respective patterns into two different pattern sets is generated.

The step of generating a reference profile comprises: converging a bias term of the hyperplane classifying the patterns to the origin of a two-dimension plane, and selecting the reference set; and generating the reference profile dependent on patterns of the reference set.

According to yet another aspect of the present invention, a method for detecting network intrusion comprises the steps of: classifying a pattern dependent on at least one packet feature value on a network into two different pattern sets according to an SVM technique; adjusting the position of a hyperplane classifying the pattern sets and selecting one reference set; generating a reference profile dependent on patterns of the reference set; and comparing feature values of a packet to the reference profile, thereby detecting network intrusion.

In the step of classifying a pattern, each pattern is preferably classified into the two pattern sets using the following formula:

$${Minimize }_{w , b , Ξ} Φ ( w , b , Ξ ) = \frac{1}{2} {‖ w ‖}^{2} + C {\sum }_{i = 1}^{l} {ξ}_{i}^{k}$$

$$Subject to {y}_{i} ( {ω}^{T} φ ( {x}_{i} ) + b ) \geq 1 - {ξ}_{i} , {ξ}_{i} \geq 0 , i = 1 , l$$

where w is an adjustable weight vector variable, xᵢ is an input-pattern vector variable, b is a bias term variable, and ξ is an error-correction variable.

In the step of selecting one reference set, a bias term of the hyperplane (ω^{T}xᵢ+b=0) which classifies the patterns into the two pattern sets is converged to the origin of a two-dimension plane, and a first pattern set is processed as an outlier of a second pattern set using the following formula:

soft margin SVM without a bias≅one-class SVM

$$\frac{1}{2} {‖ w ‖}^{2} + C {\sum }_{i = 1}^{l} {ξ}_{i}^{k} ≅ \frac{1}{2} {‖ w ‖}^{2} + \frac{1}{vl} {\sum }_{i - 1}^{l} {ξ}_{i}^{k} - p$$

$${y}_{i} ( {ω}^{T} φ ( {x}_{i} ) ) \geq 1 - {ξ}_{i} , ≅ {y}_{i} ( {ω}^{T} φ ( {x}_{i} ) ) \geq p - {ξ}_{i} , \\ 0 < v < 1 , 1 < 1 , 0 \leq p$$

where v is a variable representing the distance from the origin to the hyperplane, and l is a variable representing the maximum number of elements in a pattern set.

In the step of selecting a reference set, the reference set may be selected using the following formula:

$$Minimize \frac{1}{2} {‖ w ‖}^{2} + C {\sum }_{i = 1}^{l} {ξ}_{i}^{k} - E , 0 < C < 1$$

$$Subject to , {y}_{i} ( {ω}^{T} φ ( {x}_{i} ) ) \geq E - ξ , 0 < E < 1$$

where w is an adjustable weight vector variable, xᵢ is an input-pattern vector variable, b is a bias term variable, and ξ is an error-correction variable.

The step of classifying a pattern may comprise generating the hyperplane, classifying patterns of each pattern according to an SVM technique, by mapping the patterns to a higher dimension plane; and mapping the patterns to a two-dimension plane using a feature mapping function.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a block diagram of a system for detecting network intrusion according to an exemplary embodiment of the present invention;

FIG. 2 is a diagram illustrating patterns classified into two sets according to an exemplary embodiment of the present invention;

FIG. 3 is a diagram illustrating patterns classified into one set according to an exemplary embodiment of the present invention; and

FIG. 4 is a flowchart of a method for detecting network intrusion according to an exemplary embodiment of the present invention.

### DETAILED DESCRIPTION OF THE INVENTION

Hereinafter, exemplary embodiments of the present invention will be described in detail with reference to the accompanying drawings. In the following description, a detailed description of known functions and configurations incorporated herein has been omitted for conciseness.

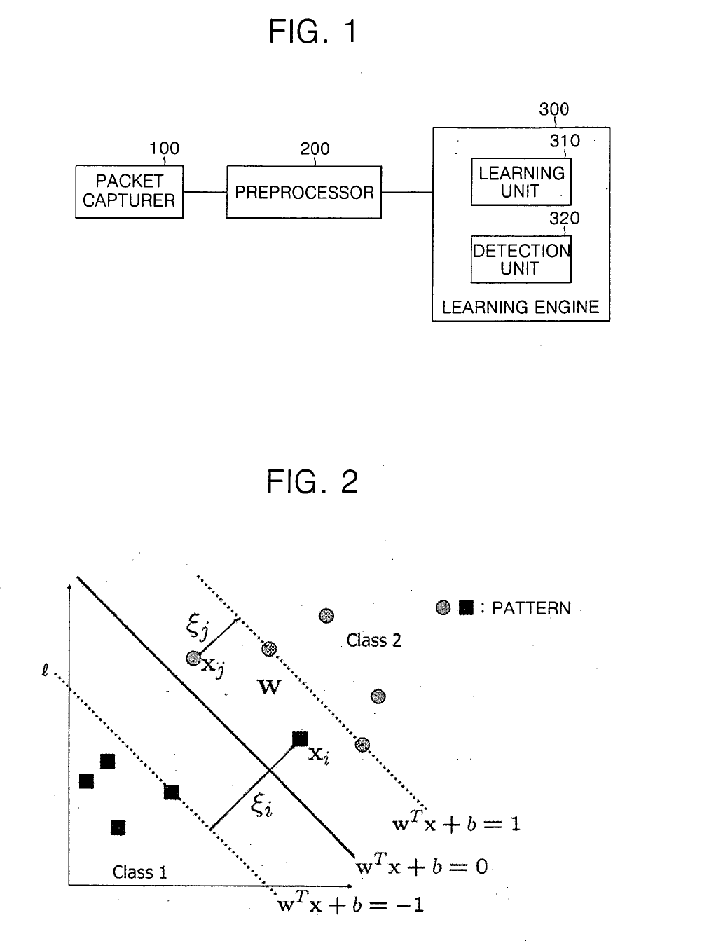

FIG. 1 is a block diagram of a system for detecting network intrusion according to an exemplary embodiment of the present invention.

Referring to FIG. 1, the network intrusion detection system comprises a packet capturer 100, a preprocessor 200, and a learning engine 300, and the learning engine 300 comprises a learning unit 310 and a detection unit 320.

The packet capturer 100 captures packets on a network randomly or for a predetermined period of time. Specifically, the packet capturer 100 captures packets on the network according to whether the object of the network intrusion detection system is a network or a host.

The preprocessor 200 converts a packet captured by the packet capturer 100 into a format for learning the packet. In other words, the preprocessor 200 preprocesses information relative to the captured packet so that the learning engine 300 can perform a learning process on the basis of the packet.

For example, the preprocessor 200 converts a captured transmission control protocol (TCP)/Internet protocol (IP) packet into feature values corresponding to each field feature of the packet.

The learning engine 300 learns feature values of each packet provided by the preprocessor 200, and detects network intrusion.

More specifically, the learning unit 310 of the learning engine 300 classifies feature values of each packet into a normal set and an abnormal set on the basis of statistical learning theory, and derives a reference profile from the normal set.

The learning unit 310 classifies patterns of a packet received when there is no historical data for detecting network intrusion into two different sets (i.e., a normal set and an abnormal set), converges a hyperplane classifying these sets to a set having extremely few pattern elements, and generates a reference profile for detecting network intrusion from one set.

The detection unit 320 compares patterns dependent on feature values of the captured packet with the reference profile so as to detect whether network intrusion has occurred.

In this regard, the learning engine 300 derives the reference profile through the learning process for a predetermined initial period of time, and then updates the reference profile according to feature values of subsequently captured packets or through the learning process at predetermined periods of time.

FIG. 2 is a diagram illustrating patterns classified into two sets according to an exemplary embodiment of the present invention.

Referring to FIG. 2, the learning engine 300 diagrams a pattern x of a captured packet according to a feature value of the packet.

Then, the learning engine 300 classifies the diagramed patterns into two different pattern sets (i.e., a normal set Class 2 and an abnormal set Class 1) using a classification algorithm which can classify the patterns.

For example, the learning engine 300 may classify the diagramed patterns into the two different pattern sets using a support vector machine (SVM) algorithm which classifies patterns into two different sets, and may generate a hyperplane l which classifies the two pattern sets using the SVM algorithm.

The following Formula 1 is a conditional formula by which the two different pattern sets are classified.

$${Minimize }_{w , b , Ξ} Φ ( w , b , Ξ ) = \frac{1}{2} {‖ w ‖}^{2} + C {\sum }_{i = 1}^{l} {ξ}_{i}^{k} \\ Subject to {y}_{i} ( {ω}^{T} φ ( {x}_{i} ) + b ) \geq 1 - {ξ}_{i} , {ξ}_{i} \geq 0 , i = 1 , l \qquad Formula 1$$

Formula 1 determines a classifier performing binary classification in the SVM algorithm. Assuming that ω^{T}xᵢ+b=0 is the hyperplane l classifying the patterns into the two pattern sets, w is an adjustable weight vector, xᵢ is an input-pattern vector, and b is a bias term.

As illustrated in FIG. 2, the two pattern sets Class 1 and Class 2 can be classified by the hyperplane (ω^{T}xᵢ+b=0)l, and errors can be corrected using ξ. For example, assuming that input patterns xₗ and xⱼ are meaningless patterns in a pattern set, the positions l′ and l″ of the hyperplane can be adjusted by correcting the bias term b of the hyperplane l by ξ.

That is, the learning engine 300 generates the hyperplane l which classifies patterns of an input packet into two pattern sets through a supervised learning process based on the SVM algorithm, and classifies the patterns into the two classes, i.e., the normal set Class 2 and the abnormal set Class 1.

In the latter regard, a determination plane classifying the two classes is the hyperplane l, and input patterns determining the hyperplane are support vectors (SVs).

When classification of the patterns into the two pattern sets is possible, the hyperplane l maximizes a distance of the support vector to the patterns, and patterns of all support vectors are located at the same minimum distance from the hyperplane.

However, since linear classification of packet patterns is extremely rare, a packet pattern set has a non-linear characteristic. Therefore, input patterns are mapped to a higher dimension plane using a technique such as a kernel trick, and are then mapped again to a two-dimension plane using a feature mapping function.

Among SVM techniques, the one-class SVM technique is a non-supervised learning-based method performing learning using only patterns of one class, i.e., one pattern set, wherein when patterns (outliers) that are not included in the pattern set are mapped from a higher dimension plane to a two-dimension plane using the feature mapping function, the patterns are located near the origin of the two-dimension plane.

In addition, as illustrated in FIG. 2, assuming that the hyperplane l is a linear function such as ω^{T}xᵢ+b=0, the positions l′ and l″ at which the hyperplane l is generated can be moved by adjusting the bias term b.

When the bias term b of the hyperplane l approaches 0, that is, when feature values included in one of two pattern sets that are classified by the hyperplane l become very small, the size of an abnormal set which is classified by the hyperplane l″ is significantly reduced.

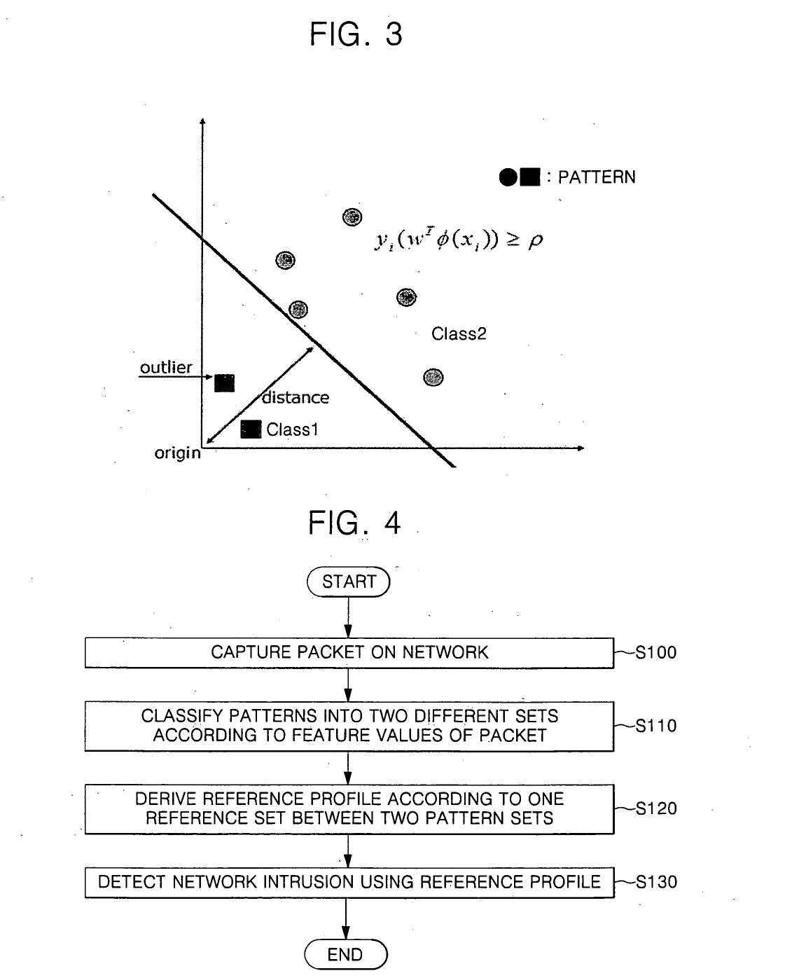

FIG. 3 illustrates patterns classified into one set according to an exemplary embodiment of the present invention.

As illustrated in FIG. 3, assuming that a bias term b of the hyperplane l is almost 0, patterns of a packet included in an abnormal set Class 1 are significantly reduced in number.

Since the number of patterns included in the abnormal set Class 1 is significantly reduced, the learning engine 300 can relatively consider the patterns that are not included in a normal set Class 2 as outliers.

In other words, the learning engine 300 classifies the patterns into the two pattern sets according to an SVM technique, learns one of the two different pattern sets, considers patterns which are not included in the learned pattern set as outliers, and thus retains only one pattern set.

Since the learning engine 300 can consider the abnormal set Class 1 classified according to features of a captured packet as the outlier of the normal set Class 2, it can derive a reference profile on the basis of the normal set Class 2.

In this regard, a soft-margin SVM technique and the one-class SVM technique according to the SVM algorithm will be briefly described. The soft-margin SVM technique displays accuracy and fast learning rate with respect to supervised learning, but has a problem in that it needs distinct definitions of two classes in the learning process.

On the other hand, the one-class SVM technique is efficient for anomaly detection because of its learning capability for a single class, but it has problems in terms of a high false positive and a low accuracy due to a unique characteristic of single class learning.

Generally, since abnormal packets are much less in number on a network than normal packets, the learning engine 300 can classify the patterns into two different pattern sets according to feature value patterns of each packet using the soft-margin SVM technique, and can consider an abnormal pattern as an error or outlier of the normal set Class 2. Therefore, the learning engine 300 retains only one pattern set, i.e., the normal set Class 2, and can generate a reference profile which can be a reference for detecting network intrusion, on the basis of the normal set Class 2.

The following Formula 2 is a comparative formula for mapping the two pattern sets according to the soft-margin SVM technique into one pattern set according to the one-class SVM technique.

$$soft margin SVM without a bias ≅ one \text{-} class SVM \\ \frac{1}{2} {‖ w ‖}^{2} + C {\sum }_{i = 1}^{l} {ξ}_{i}^{k} ≅ \frac{1}{2} {‖ w ‖}^{2} + \frac{1}{vl} {\sum }_{i - 1}^{l} {ξ}_{i}^{k} - p \\ {y}_{i} ( {ω}^{T} φ ( {x}_{i} ) ) \geq 1 - {ξ}_{i} , ≅ {y}_{i} ( {ω}^{T} φ ( {x}_{i} ) ) \geq p - {ξ}_{i} , \\ 0 < 1 , 1 < 1 , 0 \leq p \qquad Formula 2$$

In the one-class SVM technique of Formula 2, v has a trade-off relationship between the distance from the origin to the hyperplane l and the number of feature values of packets classified by the hyperplane l.

In addition, l denotes the number of patterns in an entire pattern set. In other words, the maximum number of the input packet patterns xᵢ may be l.

When a value C of the soft-margin SVM technique which has a trade-off relationship between the distance from the hyperplane l to a pattern included in the pattern set, and an error correction variable ξ remains less than 1 for the condition of the one-class SVM technique, and when p (changed into a variable E in Formula 3) is kept to a very small value between 0 and 1, the condition of the soft-margin SVM technique is changed into the following Formula 3, and a binary classifier having the characteristics of the soft-margin SVM technique and the one-class SVM technique can be generated.

$$Minimize \frac{1}{2} {‖ w ‖}^{2} + C {\sum }_{i = 1}^{l} {ξ}_{i}^{k} - E , 0 < C < 1 \\ Subject to {y}_{i} ( {ω}^{T} φ ( {x}_{i} ) ) \geq E - ξ , 0 < E < 1 \qquad Formula 3$$

As described in Formula 3, two pattern sets according to the soft-margin SVM technique can be mapped into one pattern set according to the one-class SVM technique.

Specifically, when the bias term b of the hyperplane (ω^{T}xᵢ+b=0) classifying the two different pattern sets according to the soft-margin SVM technique is converged to the origin of a two-dimension plane, the two pattern sets can be mapped into one pattern set according to the one-class SVM technique, and a reference profile can then be generated using the one pattern set.

FIG. 4 is a flowchart showing a method for detecting network intrusion according to an exemplary embodiment of the present invention.

Referring to FIG. 4, the network intrusion detection system captures a packet on a network (S100). The network intrusion detection system then classifies patterns into two different sets according to feature values of the packet (S110).

As shown in FIG. 2, the network intrusion detection system diagrams the patterns dependent on the feature values of the packet, learns each pattern according to the statistical learning theory, and classifies the patterns into two different pattern sets, i.e., a normal set and an abnormal set.

In this regard, the pattern sets can be classified by generating a hyperplane according to the soft-margin SVM technique.

In general, since normal packets are more in number on a network than abnormal packets, patterns included in the normal set Class 2 of the two different pattern sets are much more in number than patterns included in the abnormal set Class 1. Thus, it is possible to converge the bias term b of the hyperplane (ω^{T}xᵢ+b=0) to the origin.

Therefore, the patterns included in the abnormal set Class 1 between the two different pattern sets can be considered as errors or outliers of the normal set Class 2, and thus a reference profile is derived using the patterns included in the normal set Class 2 (S120).

In other words, since packets on a network include abnormal packets much less in number than the normal packets, the network intrusion detection system can classify the patterns into two different pattern sets according to feature value patterns of each packet using the soft-margin SVM technique, and can consider the abnormal patterns as errors or outliers of the normal set Class 2. Therefore, the network intrusion detection system can retain only one pattern set, i.e., the normal set Class 2, and can generate a reference profile which can be a reference for detecting network intrusion on the basis of the normal set.

The network intrusion detection system determines whether or not a packet on the network is an abnormal packet using the reference profile (S130). In other words, the network intrusion detection system detects network intrusion using the reference profile.

In the detailed description of the present invention, an example which classifies patterns into two pattern sets using the soft-margin SVM technique according to the SVM algorithm is provided, and a reference profile dependent on patterns of one pattern set is generated to detect network intrusion. In the same manner, however, a reference profile for network intrusion detection can be generated using other learning algorithms without historical data.

As described above, according to the present invention, one reference profile can be generated by learning patterns of a packet according to the SVM techniques without known historical data. Therefore, it is possible to provide the accuracy of intrusion detection and a fast learning rate without depending on historical data.

While the present invention has been described with reference to exemplary embodiments thereof, it will be understood by those skilled in the art that various changes in form and detail may be made therein without departing from the scope of the present invention as defined by the following claims.

What is claimed is:

1. A system for detecting network intrusion, comprising:
a packet capturer for capturing at least one packet on a network;
a preprocessor for providing feature values dependent on features of each said at least one packet captured by the packet capturer; and
a learning engine for classifying patterns, dependent on the feature values provided by the preprocessor, into two different pattern sets, and for selecting one pattern set having more elements from the pattern sets as a reference set so as to detect network intrusion.

2. The system of claim 1, wherein the preprocessor provides the feature values in correspondence to field values of the packet.

3. The system of claim 1, wherein the learning engine comprises:
a learning unit for generating a hyperplane classifying the patterns dependent on the feature values into the two different pattern sets, for converging a bias term of the hyperplane to an origin of a two-dimension plane so as to select the reference set, and for generating a reference profile dependent on patterns of the reference set; and
a detection unit for comparing a packet feature value on the network with the reference profile so as to detect network intrusion.

4. A system for detecting network intrusion, comprising:
a learning unit for classifying patterns dependent on at least one packet feature value on a network into two different pattern sets using a support vector machine (SVM) technique, for adjusting a position of a hyperplane classifying the pattern sets, and for generating a reference profile according to one reference set; and
a detection unit for comparing a packet feature value on the network with the reference profile so as to detect network intrusion.

5. The system of claim 4, wherein the learning unit classifies the patterns into the two pattern sets using the following formula:
$${Minimize }_{w , b , Ξ} Φ ( w , b , Ξ ) = \frac{1}{2} {‖ w ‖}^{2} + C {\sum }_{i = 1}^{l} {ξ}_{i}^{k}$$
$$Subject to {y}_{i} ( {ω}^{T} φ ( {x}_{i} ) + b ) \geq 1 - {ξ}_{i} , {ξ}_{i} \geq 0 , i = 1 , l$$
where w is an adjustable weight vector variable, xᵢ is an input-pattern vector variable, b is a bias term variable, and ξ is an error-correction variable.

6. The system of claim 5, wherein the learning unit converges a bias term of the hyperplane (ω^{T}xᵢ+b=0), classifying the patterns into the two pattern sets, to the origin of a two-dimension plane, and selects the reference set using the following formula:
soft margin SVM without a bias≅one-class SVM
$$\frac{1}{2} {‖ w ‖}^{2} + C {\sum }_{i = 1}^{l} {ξ}_{i}^{k} ≅ \frac{1}{2} {‖ w ‖}^{2} + \frac{1}{vl} {\sum }_{i - 1}^{l} {ξ}_{i}^{k} - p$$
$${y}_{i} ( {ω}^{T} φ ( {x}_{i} ) ) \geq 1 - {ξ}_{i} , ≅ {y}_{i} ( {ω}^{T} φ ( {x}_{i} ) ) \geq p - {ξ}_{i} , \\ 0 < v < 1 , 1 < 1 , 0 \leq p$$
where v is a variable representing a distance from the origin to the hyperplane, and l is a variable representing the maximum number of elements in a pattern set.

7. The system of claim 4, wherein the learning unit selects the reference set using the following formula:
$$Minimize \frac{1}{2} {‖ w ‖}^{2} + C {\sum }_{i = 1}^{l} {ξ}_{i}^{k} - E , 0 < C < 1$$
$$Subject to {y}_{i} ( {ω}^{T} φ ( {x}_{i} ) ) \geq E - ξ , , 0 < E < 1$$
where w is an adjustable weight vector variable, xi is an input-pattern vector variable, b is a bias term variable, and ξ is an error-correction variable.

8. The system of claim 4, wherein the learning unit generates the hyperplane classifying the respective patterns of each packet using a support vector machine (SVM) technique by mapping each pattern to a higher dimension plane, and processes patterns distributed at an origin after mapping the patterns as outliers to a two-dimension plane using a feature mapping function.

9. A method for detecting network intrusion, comprising the steps of:
capturing at least one packet on a network;
deriving feature values dependent on features of each said at least one captured on the network packet;
classifying the patterns dependent on the feature values into two different pattern sets;
selecting a pattern set having more elements from the two different pattern sets as a reference set so as to generate a reference profile; and
comparing a feature value of a packet with the reference profile so as to detect network intrusion.

10. The method of claim 9, wherein the step of deriving feature values comprises deriving a feature value corresponding to each field value of said at least one packet.

11. The method of claim 9, wherein the step of classifying the patterns comprises generating a hyperplane classifying respective patterns into the two different pattern sets.

12. The method of claim 9, wherein the step of selecting a pattern set to generate a reference profile comprises the steps of:
converging a bias term of a hyperplane classifying patterns to an origin of a two-dimension plane, and selecting the reference set; and
generating the reference profile dependent on patterns of the reference set.

13. A method for detecting network intrusion, comprising the steps of:
classifying patterns dependent on at least one packet feature value on a network into two different pattern sets using a support vector machine (SVM) technique;
adjusting a position of a hyperplane classifying the two different pattern sets so as to select one reference set;
generating a reference profile dependent on patterns of said one reference set; and
comparing a feature value of a packet with the reference profile so as to detect network intrusion.

14. The method of claim 13, wherein the step of classifying the patterns comprises classifying the patterns into the two pattern sets using the following formula:
$${Minimize}_{w , b , Ξ} Φ ( w , b , Ξ ) = \frac{1}{2} {‖ w ‖}^{2} + C {\sum }_{i = 1}^{l} {ξ}_{i}^{k}$$
$$Subject to {y}_{i} ( {ω}^{T} φ ( {x}_{i} ) + b ) \geq 1 - {ξ}_{i} , {ξ}_{i} \geq 0 , i = 1 , l$$
where w is an adjustable weight vector variable, xᵢ is an input-pattern vector variable, b is a bias term variable, and ξ is an error-correction variable.

15. The method of claim 13, wherein the step of adjusting a position of the hyperplane classifying the two different pattern sets so as to select one reference set comprises converging a bias term of the hyperplane (ω^{T}xᵢ+b=0) classifying the patterns into the two pattern sets to an origin of a two-dimension plane, and processing a first pattern set as an outlier of a second pattern set using the following formula:
soft margin SVM without≅bias one-class SVM
$$\frac{1}{2} {‖ w ‖}^{2} + C {\sum }_{i = 1}^{l} {ξ}_{i}^{k} ≅ \frac{1}{2} {‖ w ‖}^{2} + \frac{1}{vl} {\sum }_{i - 1}^{l} {ξ}_{i}^{k} - p$$
$${y}_{i} ( {ω}^{T} φ ( {x}_{i} ) ) \geq 1 - {ξ}_{i} , ≅ {y}_{i} ( {ω}^{T} φ ( {x}_{i} ) ) \geq p - {ξ}_{i} , \\ 0 < v < 1 , 1 < 1 , 0 \leq p$$
where v is a variable representing a distance from an origin to the hyperplane, and l is a variable representing a maximum number of elements in a pattern set.

16. The method of claim 13, wherein the step of adjusting a position of a hyperplane classifying the two different pattern sets so as to select one reference set comprises selecting the reference set for the patterns using the following formula:
$$Minimize \frac{1}{2} {‖ w ‖}^{2} + C {\sum }_{i = 1}^{l} {ξ}_{i}^{k} - E , 0 < C < 1$$
$$Subject to {y}_{i} ( {ω}^{T} φ ( {x}_{i} ) ) \geq E - ξ , , 0 < E < 1$$
where w is an adjustable weight vector variable, xᵢ is an input-pattern vector variable, b is a bias term variable, and ξ is an error-correction variable.

17. The method of claim 13, wherein the step of classifying patterns comprises generating a hyperplane classifying patterns of each said at least one packet using a support vector machine (SVM) technique by mapping the patterns to a higher dimension plane, and mapping the patterns to a two-dimension plane using a feature mapping function.
